(19) United States
(12) Patent Application Publication
(10) Pub. No.: US 2012/0281874 A1
(43) Pub. Date: Nov. 8, 2012

(54) Method, material, and apparatus to improve acquisition of human frontal face images using image template

(76) Inventor: Yuan-Ming F. Lure, McLean, VA (US)

(21) Appl. No.: 13/101,913

(22) Filed: May 5, 2011

(51) Int. Cl. G06K 9/60

(52) U.S. Cl. 382/103

(57) ABSTRACT

The present invention provides a method and apparatus to improve the image acquisition by utilizing frontal facial image template to improve acquisition of human frontal facial images.

Once image data is pre-reviewed in a display window from a human frontal facial image, the data is subjected to this biometric template matching process to allow users to aim the image capture device to features of human face such as eyes, nose, mouth, eyes, etc. This biometric template can guide users to properly position target object on image capture device, to properly position frontal facial features on image capture device, and to fast position target in the right position. Once the frontal facial images are captured, it can improve automatic image matching between two images. It provides the highest quality of the captured facial images to be prepared for face matching with strong confidence.

### BACKGROUND OF THE INVENTION

1. Technical Field

The present invention relates to methods, systems, and apparatuses for the image acquisition, and it more specifically relates to a method, system, and apparatus for the acquisition of frontal facial images for the improvement in automatic match and identification of face images. The present invention allows the users to take the human frontal face images at the optimum quality that complies with ANSI INCITS 385-2004 and ISO/IEC 19794-5.

2. Background Art

In an operation of a face recognition system, presumably, there is a watch list, or gallery of facial image database. First, a face is detected, and then the facial image is cropped to be used as a probe into the gallery to check for possible matches. The facial image is preprocessed to account for factors such as captured image resolution and illumination and to detect particular features of the face by a serial of image processes. The data from the probe image are then matched against the entries in the gallery. The facial image data record format is used to provide interoperability between uses of face recognition systems and digital facial image storage systems (image gallery or database). Measuring the quality of facial images is a crucial step in this identification process.

Performance of biometric systems depends on the quality of the acquired input samples. If quality can be improved, either by sensor design, by standards compliance, or by user interface design, better performance can be realized. For those aspects of quality that cannot be designed-in, an ability to analyze the quality of a live sample is needed. This is useful primarily in initiating the re-acquisition from a user, but also for the real-time selection of the best sample, and the selective invocation of different processing methods. It is the key component in quality assurance management, and because quality algorithms often embed the same image (or signal) analyses needed to assess conformance to underlying data interchange standards, they can be used in automated image screening applications.

Traditionally, when human face is captured with any digital cameras, the operators only make sure that the face will be covered entirely within and in the center of the viewing window of the digital camera. Because the size of coverage of human face and center of humane face are very subjective to the judgment of operators, this causes several issues for the automatic match and identification of face. This is particularly serious in capture frontal face images. This also may cause some issues in pasting photo on certain identifications such as driver license, passport, etc. where sometimes the size of human face may be too large or too small. Automatic face match and identification algorithms depend on the geometric locations of eyes for the successful recognition. A frontal face image is the most utilized image for face recognition. Almost all the feature extraction methods used in face recognition methods starts with the geometry of eyes. Even some methods using nose and mouth as starting searching landmark, geometry of eyes are always used as confirmation method. Ambient and background lighting can affect the quality of captured facial images and it is found that when eyes are positioned in a proper geometry to the image, the image quality and accuracy for face recognition are always better than adjustment of lighting. Successful identification of eyes can also help in the proper alignment and direction of face in order to minimize the inaccuracy due to the tilting in yaw angle. Because of all these requirements for accurate face recognition, matching, and image quality, the international standard bodies such as ANSI INCITS 385-2004 and ISO/IEC 19794-5 and their series of amendments have defined the geometric characteristics of token image types for capturing a frontal human face image. The standard has defined the distance between two eyes to the width of the image as well as other geometry formats. It is very difficult for operators to follow such standard during image capturing. The present invention utilizes a facial image template to allow operators to place facial features such as eyes within the scope of template that can easily meet the international standard.

Image Capturing Apparatus and Image Capturing Method by Masakazu Matsugu et al, U.S. Pat. No. 7,889,886

In an image capturing apparatus, a video input unit (2) captures the image of an object and sequentially acquires image data associated with the image capturing, a model data memory (6) stores model data associated with the first feature quantity calculated from a feature point of the object in a model image, a principal object detection unit (3) calculates the second feature quantity from a feature point of the object in the acquired image data, a state change estimation unit (4) estimates, on the basis of the second feature quantity and the model data, the timing when the object satisfies a predetermined condition, and an input processing control unit (7) stores the image data corresponding to the estimated timing in an image recording unit (5). This configuration makes the image capturing apparatus acquire an image in a more proper state without large-capacity memory. This invention presents image acquisition methods but did not address how these facial images will be acquired within a template. The current invention presents a methodology to acquire frontal facial images.

Apparatus and Method for Recognizing Facial Expressions and Facial Gestures in a Sequence of . . . by Michael J. Black et al, U.S. Pat. No. 5774591

A system tracks human head and facial features over time by analyzing a sequence of images. The system provides descriptions of motion of both head and facial features between two image frames. These descriptions of motion are further analyzed by the system to recognize facial movement and expression. The system analyzes motion between two images using parameterized models of image motion. Initially, a first image in a sequence of images is segmented into a face region and a plurality of facial feature regions. A planar model is used to recover motion parameters that estimate motion between the segmented face region in the first image and a second image in the sequence of images. The second image is warped or shifted back towards the first image using the estimated motion parameters of the planar model, in order to model the facial features relative to the first image. This invention presents image and pattern recognition methods but did not address how these facial images will be acquired. The current invention presents a methodology to acquire frontal facial images.

Target Acquisition System and Method by Jack M. Sacks et al, U.S. Pat. No. 4,739,401

A system is invented for identifying and tracking targets in an image scene having a highly cluttered background. An imaging sensor and processing subsystem provides a video image of the image scene. A size identification subsystem removes background clutter from the image by filtering the image to pass objects whose sizes are within a predetermined size range. A feature analysis subsystem analyzes the features of those objects which pass through the size identification subsystem and determines if a target is present in the image scene. A gated tracking subsystem and scene correlation and tracking subsystem track the target objects and image scene, respectively, until a target is identified. Thereafter, the tracking subsystems lock onto the target identified by the system. This invention presents image and pattern recognition methods but did not address how these facial images will be acquired. The current invention presents a methodology to acquire frontal facial images.

Target Acquisition and Tracking System by James J. Reis et al,

An automatic target acquisition and tracking system has been developed for a focal plane array seeker. The automatic target acquisition is achieved by three independent target acquisition algorithms, viz., the maximum likelihood classification, the video spatial clustering, and the target-to-interference ratio. Each algorithm operates asynchronously and provides independent target detection results. Target information is then combined hierarchically in a probabilistic fashion and prioritized. The highest priority target is handed off to a dual mode tracker consisting of a minimum absolute difference correlation tracker and a centroid tracker. The dual mode tracker subsequently provides a feedback signal to a proportional navigation system or other guidance/control system for directing the flight path of a munition. This invention presents image and pattern recognition methods but did not address how these facial images will be acquired. The current invention presents a methodology to acquire frontal facial images.

Image Combining System for Eyeglasses and Face Masks by Mark B. Spitzer, U.S. Pat. No. 5,886,822

An optical system combines a first image formed by a main lens with a second image provided by an electronic display, slide, or other image source. The image combining system includes one or more inserts such as a set of reflecting image combiners to redirect light on an optical pathway within the main lens to the user's eye. The image combining system is highly compact, allowing the integration of a display system with eyeglasses or a face mask, such as a diver's mask. A number of implementations of the optical system make possible other types of image integration including uses in image acquisition systems such as cameras. This invention presents image and pattern recognition methods but did not address how these facial images will be acquired. The current invention presents a methodology to acquire frontal facial images.

Biometric Face Recognition for Applicant Screening by John H. Payne, U.S. Pat. No. 6,072,894

Biometric facial comparison is deployed in a novel way to improve screening of applicants across multiple branch locations, preventing common forms of application fraud. The biometric facial comparison software is located at a computing location (20), readily accessible from a first applicant screening branch (30) and a subsequent applicant screening branch (40), by means of a communication network (10). The biometric facial screening is fast, affordable, nonintrusive, and takes place in person in the branch. Even if false identification documents are used, perpetrators will be automatically detected as they attempt to go from branch to branch making bogus transactions. Patterns of fraudulent behavior are detected even if no prior transaction is yet known to be fraudulent, and even if the applicant's face does not match the face of any known perpetrator. Although the first fraudulent transaction will generally not be immediately detected, detection will occur before any subsequent. This invention presents image and pattern recognition methods but did not address how these facial images will be acquired. The current invention presents a methodology to acquire frontal facial images.

Electronic Camera System with Programmable Transmission Capability by Kenneth A. Parulski et al, U.S. Pat. No. 5,666,159

An electronic camera system includes a programmable transmission capability for selectively transmitting electronic image data to a plurality of remote base units. In one embodiment, a camera module is detachably coupled to a portable computer including a display screen and a data entry device. The electronic image data generated by the camera module is supplied to the portable computer for display on the display screen. The data entry device is used by an operator to select which of the plurality of base units are to receive the digital image data. The digital image data is supplied by the portable computer to a radio-frequency transmitter module for transmission to the selected base units. The radio-frequency transmitter module is formed either integral with the portable computer or, like the camera module, is detachably coupled to the portable computer. In a further embodiment, a combined telephone/camera unit is provided that includes a camera module for generating electronic . . . This invention presents image transmission capability methods but did not address how these facial images will be acquired. The current invention presents a methodology to acquire frontal facial images.

### SUMMARY OF INVENTION

It is an object of the present invention to provide a method and apparatus to improve the image acquisition.

The automated method and apparatus of present invention overcomes the foregoing and other problems associated with the prior art by utilizing frontal facial image template to improve acquisition of human frontal facial images.

Once image data is pre-reviewed in a display window from a human frontal facial image, the data is subjected to this invented template matching process to allow users to aim the image capture device to features of human face such as eyes, nose, mouth, eyes, etc. Use of biometric template can guide users to properly position target object on image capture device, to guide users to properly position frontal facial features of a target object on image capture device, guide user for fast position target in the right position. Once the frontal facial images are captured, it can improve automatic image matching between two images. It provides the highest quality of the captured facial images to be prepared for face matching with strong confidence. This invented template can also be used as an automatic image capture of frontal facial image.

### BRIEF DESCRIPTION OF DRAWING

The features of the present invention and manner of attaining them will become apparent and the invention itself will be understood by reference to the following description and the accompanying drawing, wherein:

FIG. 1 is a diagram of face image capture system;

FIG. 2 is a block diagram of input image unit forming part of the system of FIG. 1

FIG. 3 is a block diagram of review display unit forming part of the unit of FIG. 2.

FIG. 4 is a schematic diagram of frontal facial image template overlaid on the viewing window forming part of display unit of FIG. 3

FIG. 5 is a schematic diagram of frontal facial image template overlaid on the electronic template forming part of display unit of FIG. 3

FIG. 6 is a pattern on the displayed frontal facial image template of the current invention of FIG. 4 or FIG. 5

FIG. 7 is an example of distance between each object in frontal facial image template

FIG. 8 is frontal facial image template made in a material

FIG. 9 is one of variation of the pattern on the displayed frontal facial image template of FIG. 6

FIG. 10 is one of variation of the pattern on the displayed frontal facial image template of FIG. 6

FIG. 11 is one of variation of the pattern on the displayed frontal facial image template of FIG. 6

FIG. 12 is one of variation of the pattern on the displayed frontal facial image template of FIG. 6

FIG. 13 is one of variation of the pattern on the displayed frontal facial image template of FIG. 6

FIG. 14 is one of variation of the pattern on the displayed frontal facial image template of FIG. 6

FIG. 15 is one of the usages of the current invention of FIG. 6.

FIG. 16 is a pattern on the displayed frontal facial image template of the current invention of FIG. 4 or FIG. 5

FIG. 17 is one of the usages of the current invention of FIG. 16.

### DETAILED DESCRIPTION OF THE INVENTION

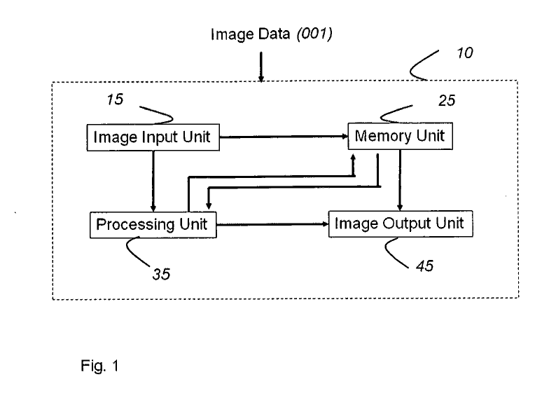

FIG. 1 illustrates the diagram of image capture system (10) for human face. The image capture system (10) may be provided by digital or analogue camera, paper scanner, or remote device that has stored the digital and digitized image. The input image (001) is first entered into the image input unit (15). The input images (001) are from the human face image, photo of face image, video camera, paper or film consisting of human faces, or images taken from other image capture devices. The input image unit (15) can be the lens, scanners, CCD devices, etc. The data stored in the image unit can be retrieved from the memory unit (25), or sent to the processing unit (35). The memory unit (25) can be a hard drive, portable disks, or laser disk. The processing unit (35) can include red eye removal, ambient light detection, etc. The output unit (45) includes the removal disks, USB port, or CD writer.

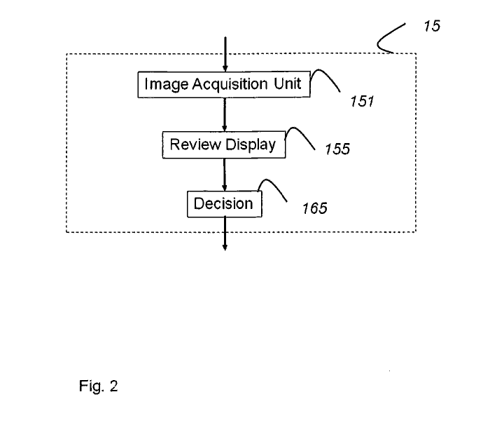

FIG. 2 illustrates a block diagram of input image unit (15) forming part of the system of FIG. 1. The input image (001) is first acquired in an image acquisition unit (151). The image acquisition unit (151) can be digital camera, scanner, video recorder, or other similar devices. The acquired image is then displayed on a review display unit (155). The review display unit (155) can be a viewing window in digital camera, video recorder, computer monitor, or TV monitor, etc. Users can look at image displayed on a review display unit (155) to make decision to capture the image or not in decision unit (165). The decision unit (165) can be a button, mouse, foot pedal, touch screen, or other similar device, to allow user to take action to capture the image. Once user decides to capture the image, image acquisition unit (151) will acquire the image. The acquired image will be sent to memory unit (25) or the processing unit (35).

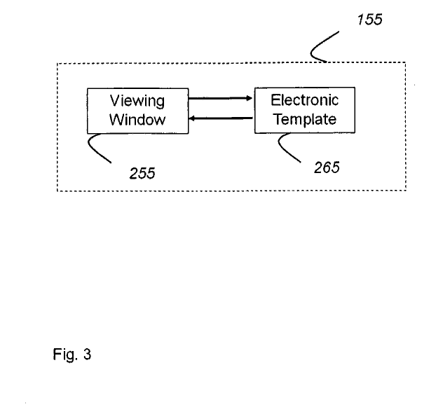

FIG. 3 is a block diagram of review display unit forming part of the unit of FIG. 2. The Review display (155) consists of viewing window (255) and its corresponding electronic template (265). The electronic template (265) is attached to the viewing window (255). The viewing window can be a small display panel in a digital camera, a computer monitor, or other similar devices. In a digital camera, a previewed image is transmitted directly from the lens to the viewing window (255) without storing. In a paper scanner, the previewed image is scanned by the scanner at coarse resolution and contrast and displayed on the electronic template (265). The viewing window (255) displays previewed image for user to evaluate and to determine whether to capture and store into processing unit (35) or memory unit (25). The electronic template (265) can be a rectangle area to allow the image to be displayed within. The electronic template (265) displays previewed image for user to evaluate and to determine whether to capture and store into processing unit (35) or memory unit (25). The electronic template (265) also includes several indicators such as the length of battery, the readiness of flashlight, the usage of memory, etc.

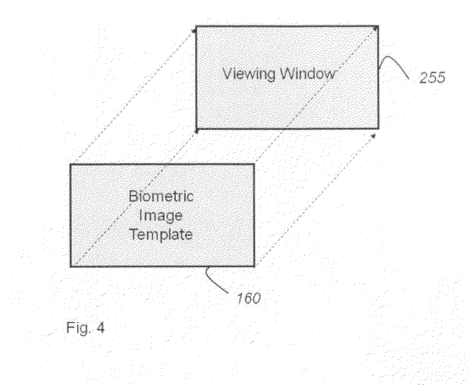

FIG. 4 is a schematic diagram of frontal facial image template (160) of current invention overlaid on the viewing window (255) forming part of display unit of FIG. 3. The frontal facial image template (160) of the current invention can be an additional material, device, drawing, or similar devices directly attached to the viewing window (255). The frontal facial image template (160) is designed to be used as a guide to allow user to align the previewed image within its template before acquisition.

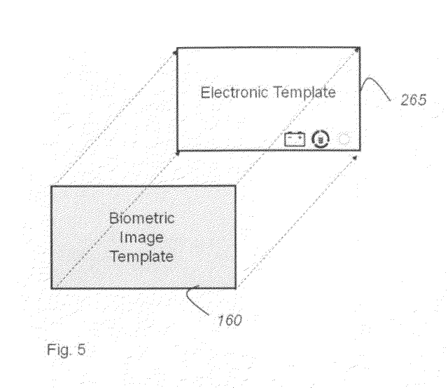

FIG. 5 is a schematic diagram showing an alternative overlay of the frontal facial image template (160) on the electronic template (265) forming part of display unit of FIG. 3. The frontal facial image template (160) of the current invention is an electronic template attached to the existing electronic template (265). The frontal facial image template (160) is designed to be used as a guide to allow user to align the previewed image within its template before acquisition. The electronic template (265) can show the length of battery, background contrast, etc.

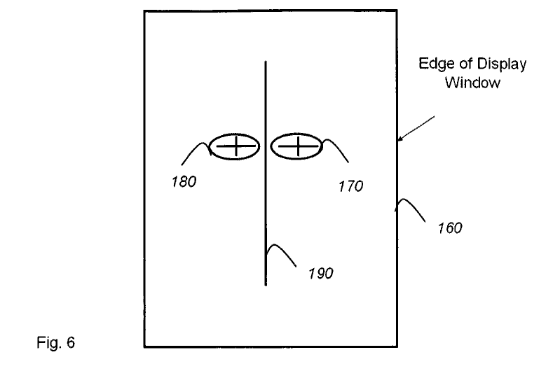

FIG. 6 is a pattern on the displayed frontal facial image template (160) of the current invention of FIG. 4 or FIG. 5. The pattern consists of 2 oval areas (170 and 180) and “+” sign inside the oval area. A vertical line (190) is drawn perpendicular to the axis of two oval areas (170 and 180). The two oval areas (170 and 180) are designed to be used by users to place each eye of a human facial image inside each of these oval areas before image is captured. The vertical line (190), identified as nose line, is used by users to align the nose in a facial image.

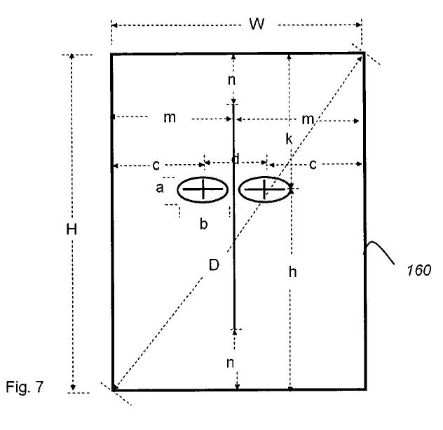

FIG. 7 is an example of distance between each object in frontal facial image template (160). The definition of each distance is below.
D: diagonal distance of frontal facial image template
W: Width of frontal facial image template
H: Height of frontal facial image template
d: distance between centers of eyes
h: distance from bottom of frontal facial image template to eye center
k: distance from the top of frontal facial image template to eye center
a: height of eye
b: width of eye
c: distance from the right edge of frontal facial image template to the center of right eye
T: thickness of eye boundary
m: center of face or distance from the nose center to the edge of frontal facial image template
n: distance from top (or bottom) of frontal facial image template to top of ‘nose line”

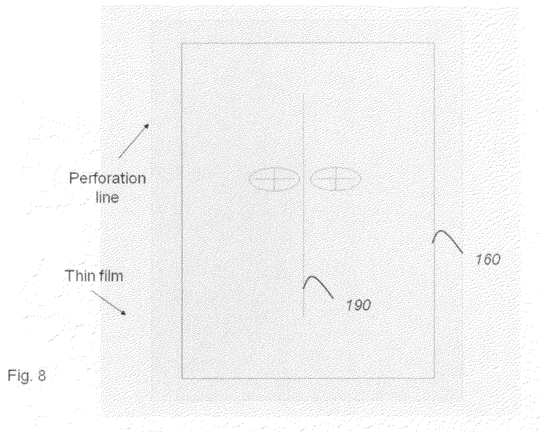

FIG. 8 is frontal facial image template made in a material. The frontal facial image template (160) can be drawn in a transparent material such as thin film, plastic, etc. such that this frontal facial image template (160) can be adhesive or attached to the outside of the viewing window (255).

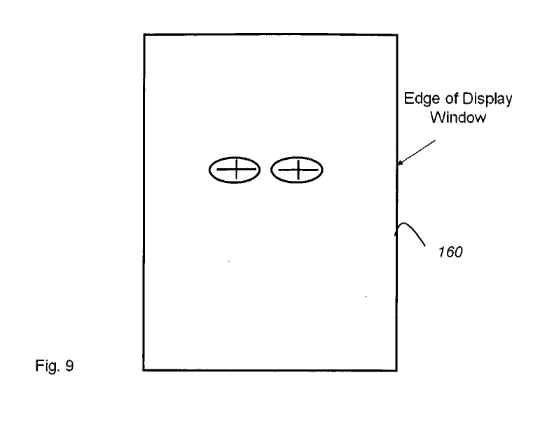

FIG. 9 is one of variation of the pattern on the displayed frontal facial image template of FIG. 6. The nose line (the vertical line) (190) is removed from the template (160).

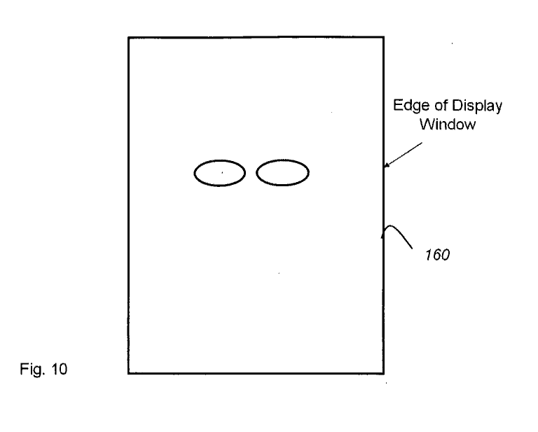

FIG. 10 is one of variation of the pattern on the displayed frontal facial image template of FIG. 6. The nose line (the vertical line) (190) and two “+” are removed from the template (160).

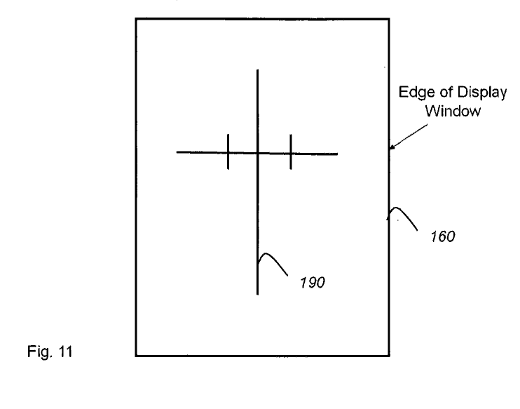

FIG. 11 is one of variation of the pattern on the displayed frontal facial image template of FIG. 6. The two ovals are removed from the template (160). The horizontal lines inside two “+”s are extended and connected, in perpendicular to the nose line (190).

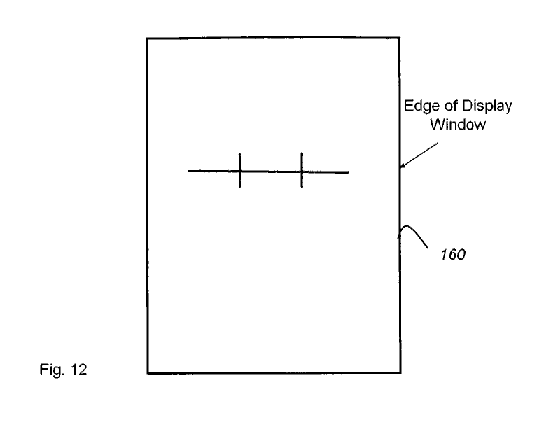

FIG. 12 is one of variation of the pattern on the displayed frontal facial image template of FIG. 6. The horizontal lines inside two “+”s are extended and connected, in perpendicular to the nose line (190) and the nose line (190) is removed.

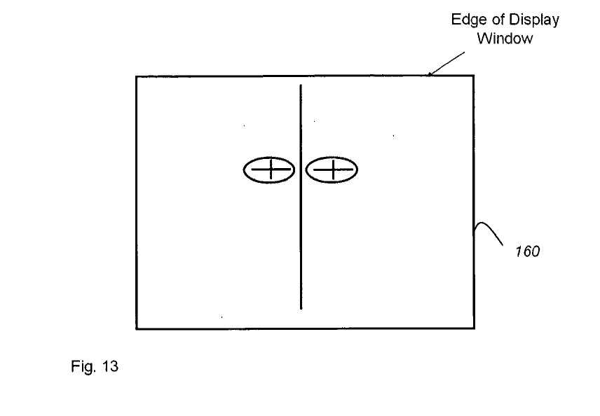

FIG. 13 is one of variation of the pattern on the displayed frontal facial image template of FIG. 6. The overall frame is rotated by 90%.

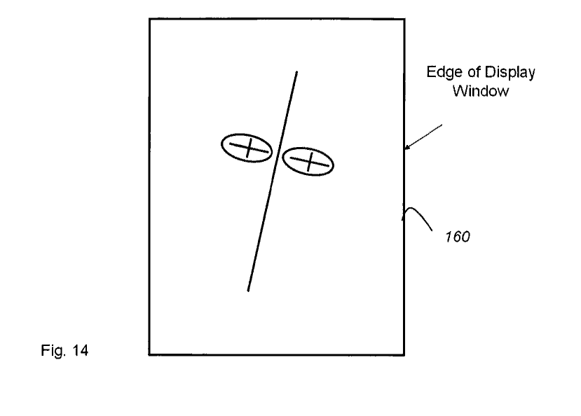

FIG. 14 is one of variation of the pattern on the displayed frontal facial image template of FIG. 6. The edge of the display window is tilted.

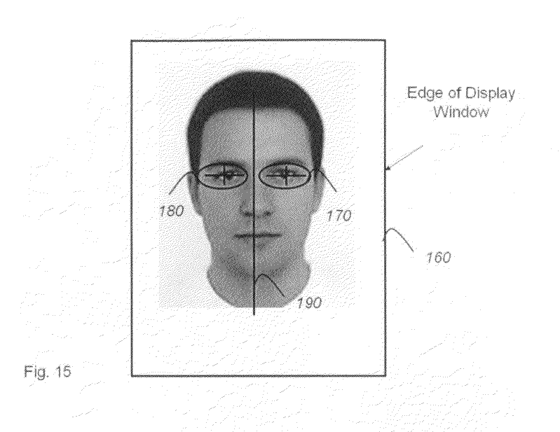

FIG. 15 is usage of the frontal facial image template (160) of the current invention to guide users to properly position target object on image capture device. It is the usage of the frontal facial image template (160) of the current invention to guide users to properly position frontal facial features of a target object on image capture device. It also guides user for fast position target in the right position.

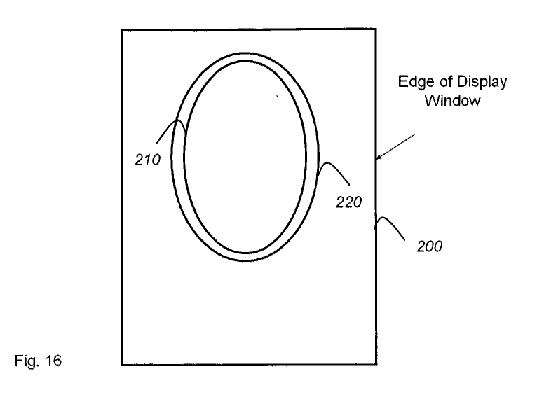

FIG. 16 is another pattern on the displayed frontal facial image template (200) of the current invention of FIG. 4 or FIG. 5. The pattern consists of 2 concentric oval areas (210 and 220). One of an oval area can be same or smaller than another oval area. The two oval areas (210 and 220) are designed to be used by users to place the edge of a human facial image between these oval areas before image is captured.

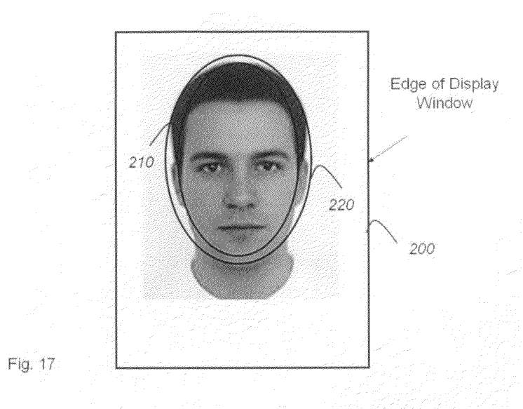

FIG. 17 is usage of the frontal facial image template (200) of the current invention to guide users to properly position target object on image capture device. It is the usage of the frontal facial image template (200) of the current invention to guide users to properly position frontal facial features of a target object on image capture device. It also guides user for fast position target in the right position.

What is claimed is:

1. A method for the acquisition of image, such as human facial image, the system comprising
an image acquisition method,
a review display method that consists of viewing window, frontal facial image template, and an electronic template, and
a decision method that consists of switch to allow users to capture the digital image.

2. A method according to claim 1, wherein said frontal facial image template, can be image template printed on a medium or electronic image template

3. A method according to claim 1, wherein said frontal facial image template, uses frontal facial features as templates

4. A method according to claim 1, wherein said frontal facial image template, uses boundary of review window as its referenced boundary

5. A method according to claim 3, wherein said frontal facial features, is visible features in human face

6. A method according to claim 5, wherein said visible features in human face, is description of eyes, nose, mouth, and ears

7. A method according to claim 6, wherein said description, is locations, shapes, masks, drawings, distances, and sizes.

8. A method according to claim 7, wherein distances between said visible features in human face, are pre-determined

9. A method according to claim 7, wherein sizes of said visible features in human face, are pre-determined

10. A method according to claim 7, wherein shape of said visible features in human face, are pre-determined

11. A method according to claim 3, wherein said frontal facial image template can be removed and added to the review window or electronic template.

12. An apparatus for the acquisition of image, such as human facial image, the system comprising
an image acquisition apparatus,
a review display apparatus that consists of viewing window, frontal facial image template, and an electronic template, and
a decision apparatus that consists of switch to allow users to capture the digital image.

13. An apparatus according to claim 12, wherein said frontal facial image template, can be image template printed on a medium or electronic image template

14. An apparatus according to claim 12, wherein said frontal facial image template, uses frontal facial features as templates

15. An apparatus according to claim 12, wherein said frontal facial image template, uses boundary of review window as its referenced boundary

16. An apparatus according to claim 13, wherein said frontal facial features, is visible features in human face

17. An apparatus according to claim 16, wherein said visible features in human face, is description of eyes, nose, mouth, and ears

18. An apparatus according to claim 17, wherein said description, is locations, shapes, masks, drawings, distances, and sizes.

19. An apparatus according to claim 18, wherein distances between said visible features in human face, are pre-determined

20. An apparatus according to claim 18, wherein sizes of said visible features in human face, are pre-determined

21. An apparatus according to claim 18, wherein shape of said visible features in human face, are pre-determined

22. An apparatus according to claim 13, wherein said frontal facial image template can be removed and added to the review window or electronic template.
